(19) United States
(12) Patent Application Publication
(10) Pub. No.: US 2026/0296149 A1
(43) Pub. Date: Oct. 1, 2026

(54) RECREATIONAL VEHICLE WITH DOOR ASSEMBLY

(71) Applicant: Textron Inc., Providence, RI (US)

(72) Inventor: Bradley Austin Bahorich, Grovetown, GA (US)

(73) Assignee: Textron Inc., Providence, RI (US)

(21) Appl. No.: 19/096,125

(22) Filed: Mar. 31, 2025

(51) Int. Cl. B60J 5/04; B60P 1/43

(52) U.S. Cl. CPC B60J 5/0487; B60P 1/435

(57) ABSTRACT

A recreational vehicle includes a chassis, a body, a prime mover, a plurality of tractive elements, and a door assembly. The body is coupled to the chassis and defines an occupant area. At least one of the plurality of tractive elements is driven by the prime mover. The door assembly is reconfigurable between (i) a first state in which the door assembly defines at least a portion of a door for the occupant area and (ii) a second state in which the door assembly defines at least one of a ramp, a table, or a bed.

### BACKGROUND

Vehicles with ramps are designed to provide access to individuals using wheelchairs and enable loading of cargo onto the vehicle. Vehicles with doors provide access, security, and protection for passengers and cargo.

### SUMMARY

One embodiment relates to a recreational vehicle. The recreational vehicle includes a chassis, a body coupled to the chassis, a prime mover, a plurality of tractive elements, and a door assembly. At least one of the plurality of tractive elements is driven by the prime mover. The body defines an occupant area. The door assembly is reconfigurable between (i) a first state in which the door assembly defines at least a portion of a door for the occupant area and (ii) a second state in which the door assembly defines at least one of a ramp, a table, or a bed.

Another embodiment relates to a recreational vehicle. The recreational vehicle includes a chassis, a prime mover, a body coupled to the chassis, a plurality of tractive elements, a sensor configured to facilitate detecting a vehicle characteristic, a door assembly, and a control system. The body defines an occupant area. At least one of the plurality of tractive elements is driven by the prime mover. The door assembly is reconfigurable between (i) a first state in which the door assembly defines at least a portion of a door for the occupant area and (ii) a second state in which the door assembly defines at least one of a ramp, a table, or a bed. The control system is configured to acquire a state of the door assembly, acquire the vehicle characteristic from the sensor and acquire a proximity characteristic from the sensor. The proximity characteristic includes a distance between the recreational vehicle and an obstacle. The control system is configured to restrict movement of the door assembly from the first state to the second state in response to determining that the recreational vehicle is in motion based on the vehicle characteristic, restrict movement of the recreational vehicle when the control system determines the door assembly is in the second state, and restrict movement of the door assembly from the first state to the second state when the distance is less than a threshold.

Still another embodiment relates to a recreational vehicle. The recreational vehicle includes a chassis, a body coupled to the chassis, and a door assembly. The body defines an occupant area. The door assembly includes a main body and an extension panel pivotably coupled to the main body. The door assembly is reconfigurable between (i) a first state in which the main body provides at least a portion of a door for the occupant area, (ii) a second state in which the main body and the extension panel provides a ramp, and (iii) a third state in which the extension panel provides a tabletop.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle including a door assembly in a first state, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a perspective view of the vehicle of FIG. 1 including the door assembly in a second state, according to an exemplary embodiment.

FIG. 6 is a perspective view of the door assembly of FIG. 1, according to an exemplary embodiment.

FIG. 7 is a right-side view of the door assembly of FIG. 6 in the first state, according to an exemplary embodiment.

FIG. 8 is a perspective view of the door assembly of FIG. 1 in a second state, according to an exemplary embodiment.

FIG. 9 is a front view of the door assembly of FIG. 8 in the second state, according to an exemplary embodiment.

FIG. 10 is a left-side view of the door assembly of FIG. 8 in the first state, according to an exemplary embodiment.

FIG. 11 is a perspective view of the door assembly of FIG. 1 in a second state, according to an exemplary embodiment.

FIG. 12 is a left-side view of the door assembly of FIG. 11 in the first state, according to an exemplary embodiment.

FIG. 13 is a perspective view of the vehicle of FIG. 1, including the door assembly in a second state, according to an exemplary embodiment.

FIG. 14 is a perspective view of the vehicle of FIG. 1, including the door assembly in the first state, according to an exemplary embodiment.

FIG. 15 is a perspective view of the vehicle of FIG. 14, including the door assembly transitioning between the first state and a second state, according to an exemplary embodiment.

FIG. 16 is a perspective view of vehicle of FIG. 15, including the door assembly in the second state, according to an exemplary embodiment.

FIG. 17 is a perspective view of the vehicle of FIG. 14, including the door assembly transitioning between the first state and a second state, according to an exemplary embodiment.

FIG. 18 is a perspective view of vehicle of FIG. 17, including the door assembly in the second state, according to an exemplary embodiment.

FIG. 19 is a perspective view of vehicle of FIG. 14, including the door assembly in the first state, according to an exemplary embodiment.

FIG. 20 is a flow diagram for a method for reconfiguring the door assembly between a first and a second state, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

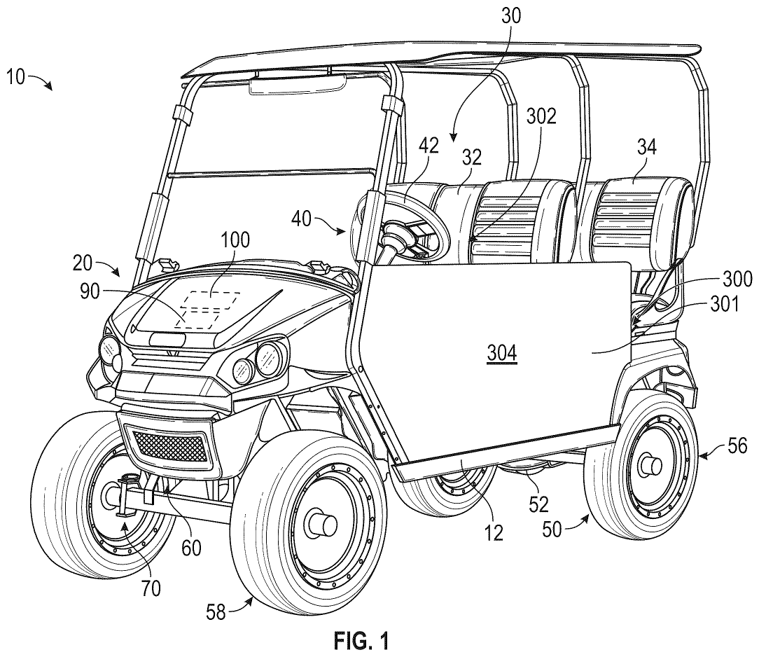

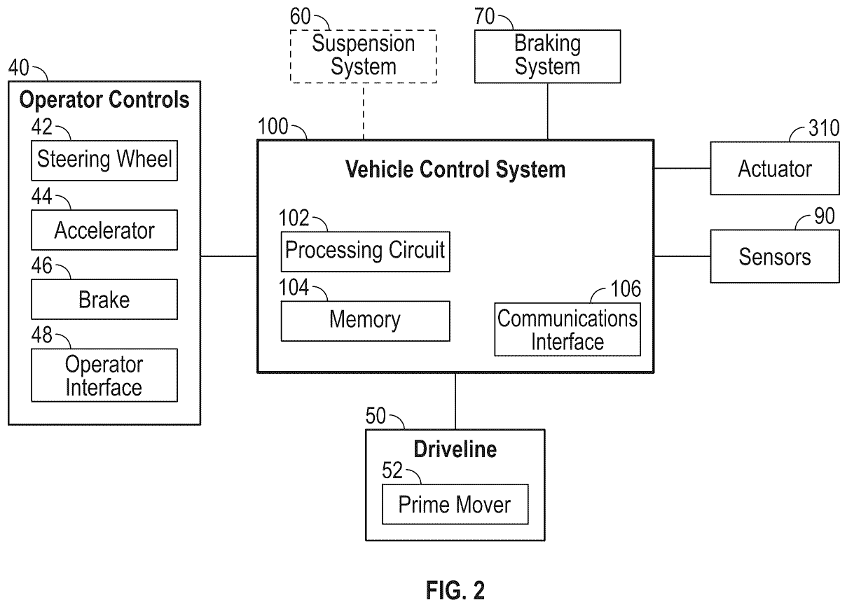

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a light utility vehicle (“LUV”), a car carrier trailer (e.g., a car-carrying trailer, a car hauler, an auto transport trailer, etc.), a ground support equipment (“GSE”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

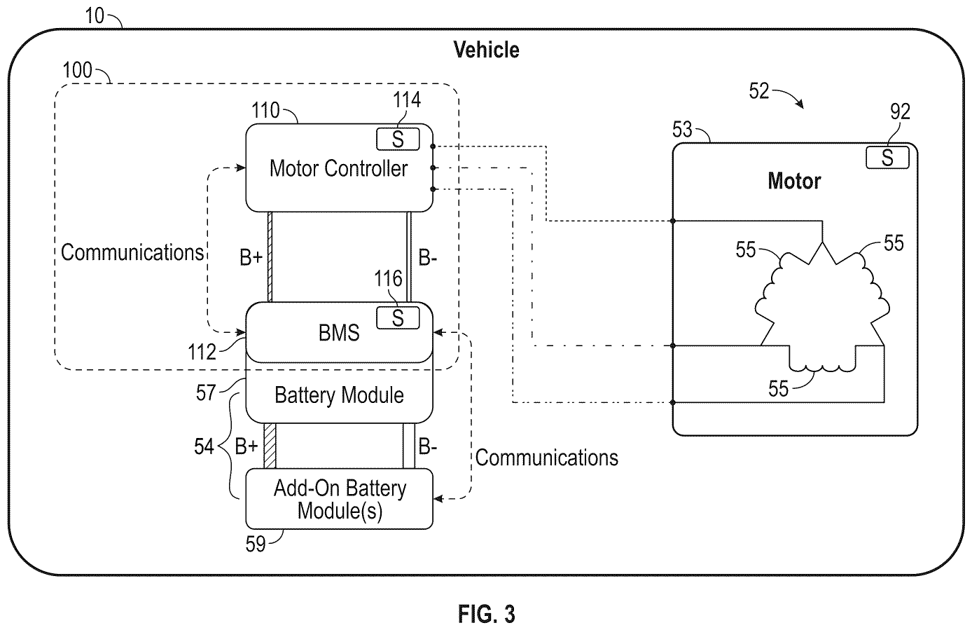

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

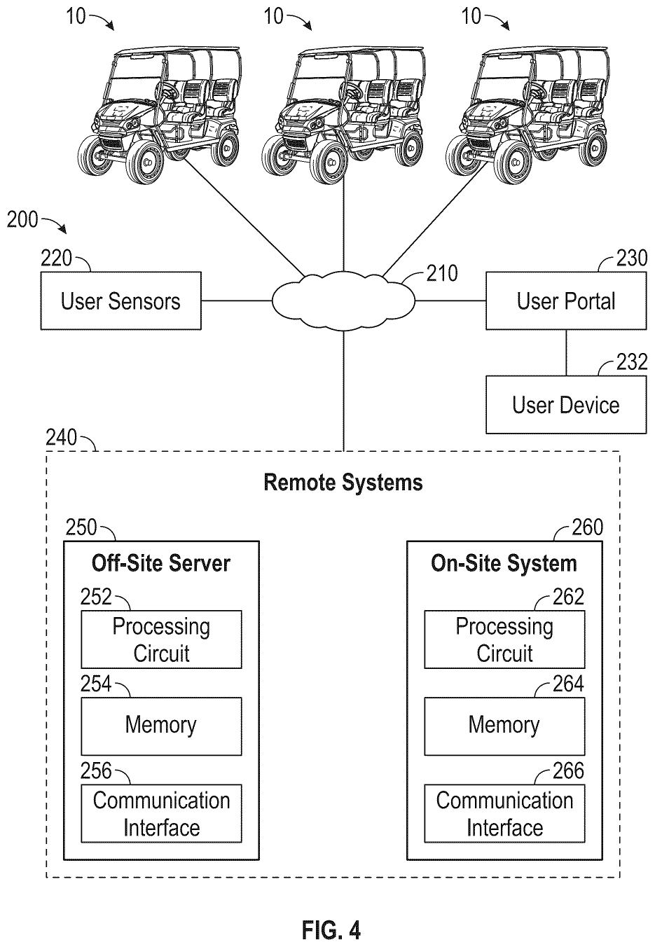

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Vehicle With Door Assembly

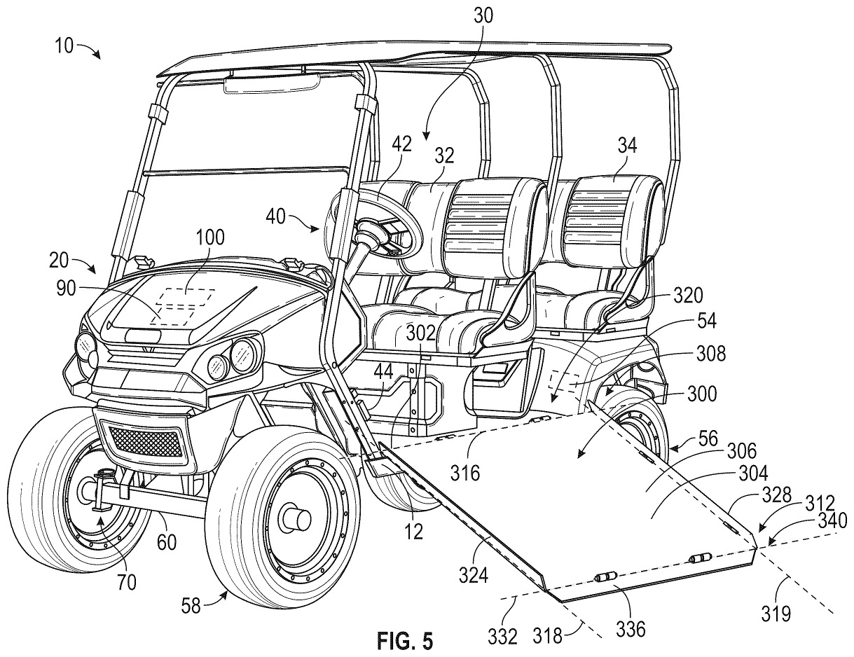

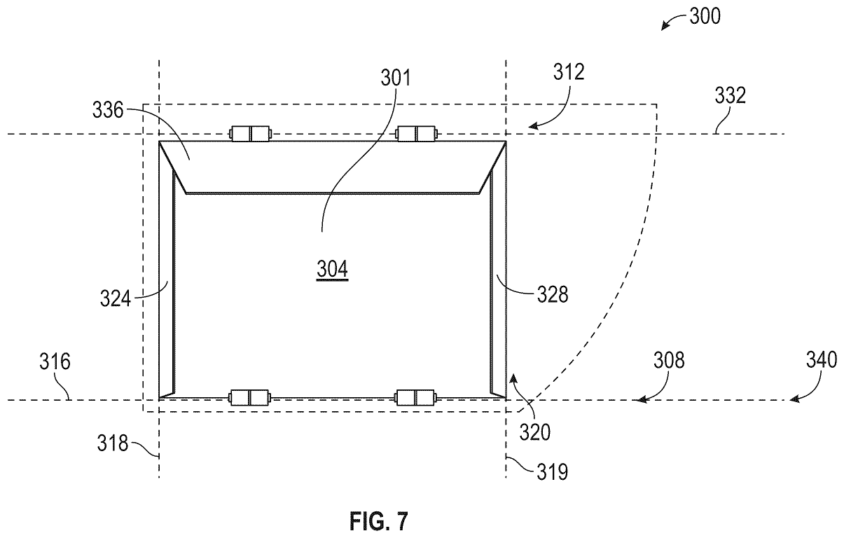

As shown in FIGS. 1 and 5-19, the vehicle 10 includes an entry assembly, shown as door assembly 300, and floor, shown as a vehicle floor 302. As shown in FIG. 1, in a first state, the door assembly 300 defines at least a portion of an entrance, shown as door 301, for the occupant seating area 30. The door 301 is defined by a body, shown as main body 304, that extends along the frame 12 and/or body 20 of the vehicle 10, and is configured to form to a shape of the frame 12 and/or the body 20 (e.g., the main body 304 meshes with the frame 12 of the vehicle 10, etc.). In some embodiments, as shown in FIG. 7, the main body 304 defines a rectangular door 301. As shown in FIGS. 1 and 5, the main body 304 is pivotably coupled to the frame 12. As shown in FIGS. 5-7, the main body 304 is pivotable relative to a lateral edge of the frame 12 about a first axis, shown as first pivot axis 316. In some embodiments, the main body 304 is pivotable relative to a longitudinal edge of the frame 12 in addition to or instead of the first pivot axis 316.

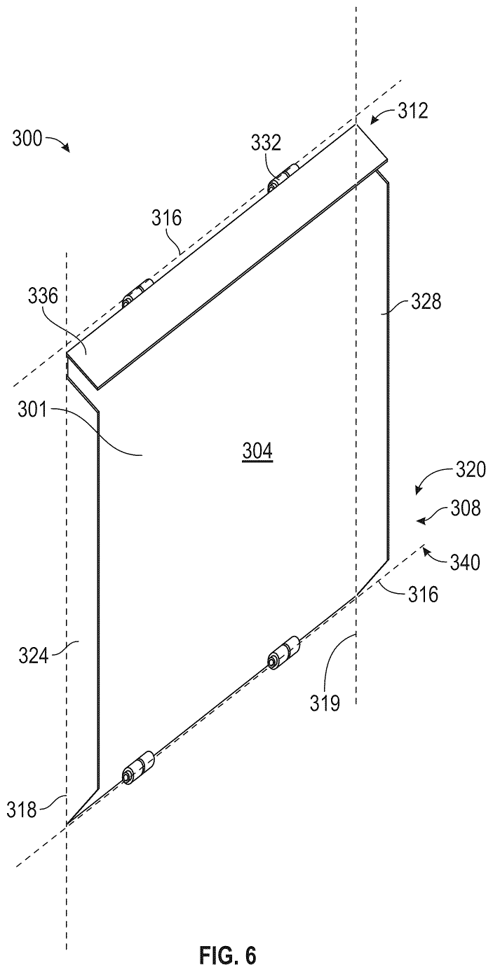

As shown in FIG. 5, in a second state, the door assembly 300 defines an incline, shown as ramp 306. As shown in FIG. 2, the door assembly 300 is reconfigurable between the first state and the second state by at least one of an actuator, shown as actuator 310 (e.g., an electric actuator, a pneumatic actuator, a motor, a linear actuator, etc.) or a spring (e.g., damper). As shown in FIGS. 6 and 7, the door assembly 300 includes a plurality of first fasteners, shown as first fasteners 308; a second axis, shown as second pivot axis 318; a third axis, shown as third pivot axis 319; a plurality of second fasteners, shown as fasteners 312; a fourth axis, shown as fourth pivot axis 332; and a plurality of extensions, shown as rails 320. The rails 320 include first rail, shown as first rail 324; a second rail, shown as second rail 328; and an extension portion shown as extension panel 336. The rails 320 extend along edges of the main body 304. The first fasteners 308 are configured to hingedly couple the main body 304 to the vehicle floor 302 of the vehicle 10. The first pivot axis 316 is provided about the first fasteners 308, and is configured to pivot (e.g., rotate, etc.) the main body 304 about the first pivot axis 316. The first pivot axis 316 enables the door assembly 300 to transform between the door 301 and the ramp 306. In the illustrated embodiment, the ramp 306 is formed as a rectangle. In some embodiments, the ramp 306 is shaped as a door shaped to fit within a frame 12, such as in FIG. 5.

As shown in FIGS. 5-7, the first rail 324 extends along a first edge of the main body 304 and the second rail 328 extends along a second edge of the main body 304, the first edge being opposite the second edge. The first rail 324 extends along the second pivot axis 318 and the second rail 328 extends along the third pivot axis 319. The first rail 324 is configured to pivot (e.g., rotate, etc.) about the second pivot axis 318 and the second rail 328 is configured to pivot (e.g., rotate, etc.) about the third pivot axis 319. The first rail 324 is pivotable relative to the main body 304 about the second pivot axis 318. The second rail 328 is pivotable relative to the main body 304 about the third pivot axis 319. The first rail 324 and the second pivot axis 318 are configured to rotate until each of the first rail 324 and the second rail 328 are substantially perpendicular to the main body 304. The first rail 324 and the second rail 328 are configured to provide a barrier (e.g., rail guard, etc.) for the main body 304. For example, when a user in a wheelchair is entering the occupant seating area 30, the first rail 324 and the second rail 328 may prevent the wheelchair from falling off of the main body 304. When the door assembly 300 is in the first state and forms the door 301, as shown in FIG. 1, the first rail 324 and the second rail 328 are configured to pivot towards the main body 304 and face the occupant seating area 30 so as to provide a more seamless visual appearance of the door 301 from outside of the vehicle 10. In some embodiments, the first rail 324 and the second rail 328 pivot toward the main body 304 and face the outside of the vehicle 10 when the door assembly 300 is in the first state. In the illustrated embodiment, when the main body 304 is formed as a rectangle, the first rail 324 is substantially parallel to the second rail and second pivot axis 318 and the third pivot axis 319 are each substantially orthogonal to the first pivot axis 316.

As shown in FIGS. 5-7, the extension panel 336 extends from a free end of the main body 304 opposite the vehicle floor 302. The extension panel 336 is pivotably coupled to the main body 304. The extension panel 336 is configured to pivot (e.g., rotate) about the second fasteners 340 and the fourth pivot axis 332. The extension panel 336 is pivotable relative to the main body 304 about the fourth pivot axis 332. The second fasteners 340 hingedly couple the extension panel 336 to the main body 304. The extension panel 336 is configured to pivot to contact a ground surface when the door assembly 300 is in the second state. The extension panel 336 prevents the main body 304 from contacting the ground surface and enables a smooth transition between the main body 304 and the ground, providing a more comfortable path for a wheelchair user. The extension panel 336 also prevents small objects, debris, or liquids from accumulating at a base of the main body 304 near the ground surface. When the door assembly 300 is in the first state and forms the door 301, as shown in FIG. 1, the extension panel 336 is configured to pivot towards the main body 304 and face the occupant seating area 30 so as to provide a more seamless visual appearance of the door 301 from outside of the vehicle 10. In some embodiments, the extension panel 336 pivots toward the main body 304 and faces the outside of the vehicle 10 when the door assembly 300 is in the first state. The fourth pivot axis 332 is substantially parallel to the first pivot axis 316. In some embodiments, as shown in FIGS. 5-7, when the main body 304 defines a rectangle, the fourth pivot axis 332 is substantially perpendicular to the second pivot axis 318 and the third pivot axis 319. In some embodiments, the second pivot axis 318 and the third pivot axis 319 form alternate configurations. For example, when the main body 304 is formed to seamlessly integrated with a side of the vehicle 10 when in the first state, as shown in FIG. 1, the second pivot axis 318 and the third pivot axis 319 may be acute or obtuse with respect to the fourth pivot axis 332.

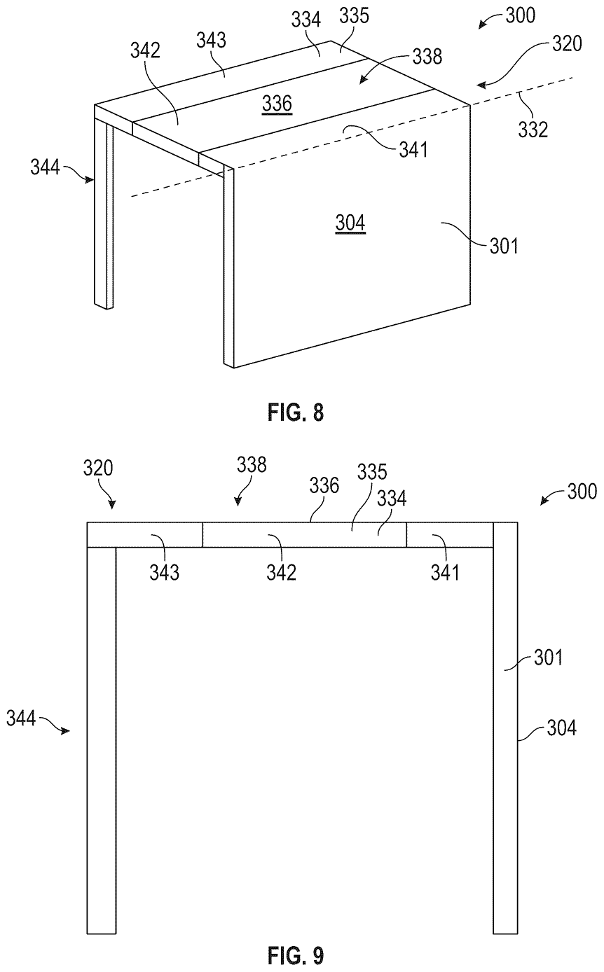

As shown in FIGS. 8 and 9, in the second state, the door assembly 300 defines at least one of a counter (e.g., bed, platform, etc.), shown as table 334; or a platform, shown as bed 335, according to an exemplary embodiment. The door assembly 300 also defines a portion of the door 301. In some embodiments, the door assembly 300 defines the at least one of the table 334 or the bed 335 in second state and the ramp 306 in a third state. In some embodiments, the door assembly 300 defines the ramp 306 in the second state and the at least one of the table 334 or the bed 335 in the third state. The extension panel 336 extends substantially perpendicular from the main body 304 to define the table 334 or the bed 335. The extension panel 336 defines an extendable mechanism, shown as telescoping mechanism 338. The telescoping mechanism 338 is configured to telescope to define the table 334 or the bed 335. The telescoping mechanism 338 includes a first portion, shown as first telescoping portion 341; a second portion, shown as second telescoping portion 342; and a third portion, shown as third telescoping portion 343. The extension panel 336 is configured to pivot about the fourth pivot axis 332 to be substantially perpendicular to the main body 304, and telescope toward the occupant seating area 30 of the vehicle 10. The third telescoping portion 343 extends from the second telescoping portion 342, and the second telescoping portion 342 extends from the first telescoping portion 341. In some embodiments, the extension panel 336 includes more or less than three portions (e.g., 6 portions, etc.).

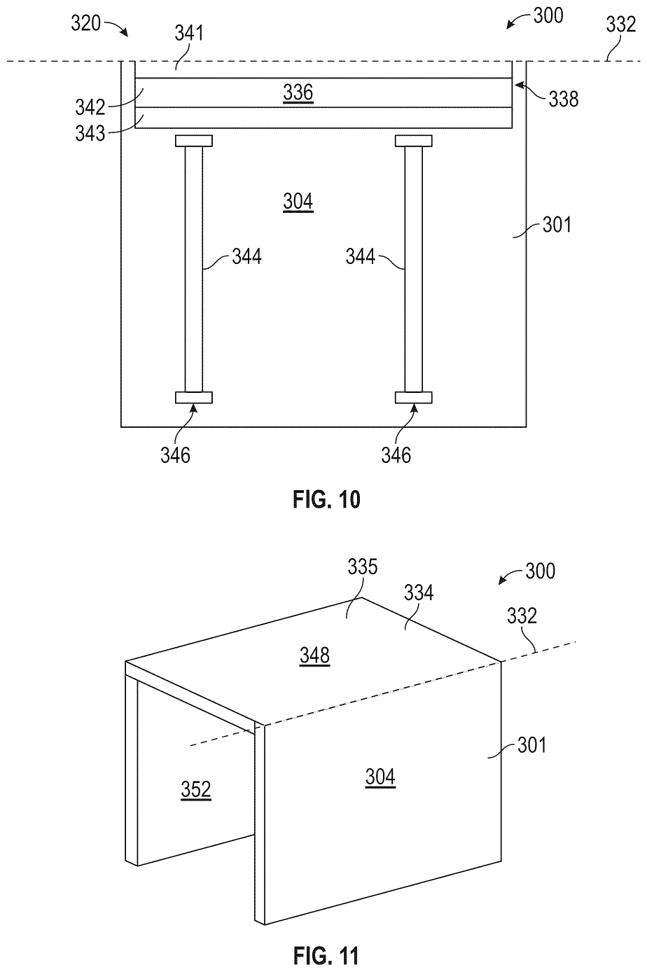

The door assembly 300 further includes one or more legs, shown as legs 344; and one or more coupling mechanism, shown as attachment pieces 346. As shown in FIG. 10, in the first state the legs 344 are coupled to the main body 304 via the attachment pieces 346 and confront the occupant seating area 30 when the door assembly 300 is in the first state. The legs 344 may be removed from the main body 304 and coupled to the third telescoping portion 343 (e.g., coupled to the extension panel 336, etc.) in the second state to form a bed 335 or a table 334, as shown in FIGS. 8 and 9. In some embodiments, the legs 344 are pivotably coupled to the extension panel 336.

As shown in FIG. 11, in the second state, the door assembly 300 defines a table 334 or a bed 335, according to an exemplary embodiment. The door assembly 300 also defines at least a portion of the door 301. The door assembly 300 includes a top portion, shown as tabletop 348, and the vehicle 10 includes a second door assembly, shown as second door assembly 352. The second door assembly 352 is configured similarly to the door assembly 300 and is capable of performing the same functions of the door assembly 300. The door assembly 300 extends along a first side of the occupant seating area 30 and the second door assembly 352 extends along a second side of the occupant seating area 30 opposite the first side. The tabletop 348 is configured to couple to an edge of the main body 304 along the fourth pivot axis 332, extend across the occupant seating area 30, and contact the second door assembly 352 to form the table 334 or the bed 335. The tabletop 348 is substantially perpendicular to the main body 304 and the second door assembly 352. The tabletop 348 extends laterally outward from the main body 304. In the illustrated embodiment, the tabletop 348 forms a rectangle. In some embodiments, the tabletop 348 forms an alternate shape (e.g., a square, a polygon, etc.).

In some embodiments, the tabletop 348 is formed similarly to the telescoping mechanism 338 of FIGS. 8-10 and coupled to the main body 304 and telescope across the occupant seating area 30 to the second door assembly 352. In some embodiments, the tabletop 348 includes the telescoping mechanism 338 and is formed from the extension panel 336. For example, the extension panel 336 extends from the main body 304 towards the second door assembly 352 and a free end of the extension panel 336 is supported by a second door of the second door assembly 352.

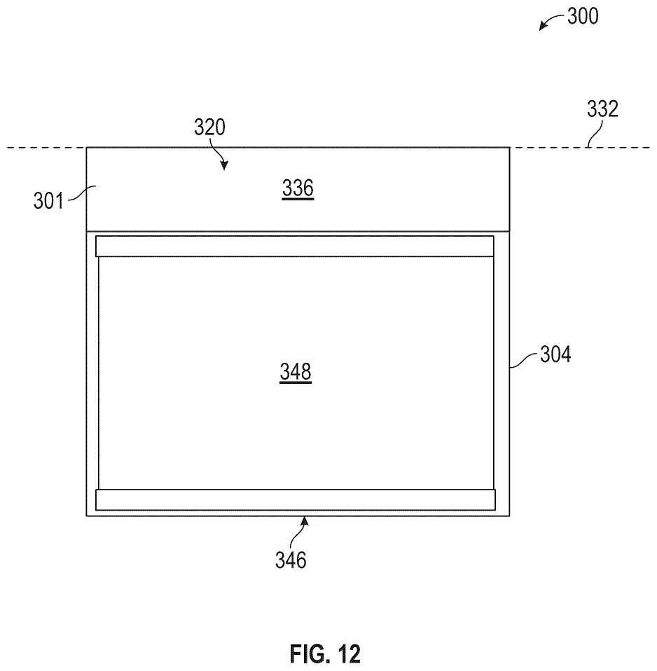

As shown in FIG. 12, in the first state the door assembly 300 defines the door 301. The door assembly 300 includes the attachment pieces 346 and the tabletop 348 detached from an edge of the main body 304. The tabletop 348 is coupled to (e.g., stowed within, etc.) the main body 304 via the attachment pieces 346. The tabletop 348 is removed from the attachment pieces 346 when transitioning to the second state of FIG. 11.

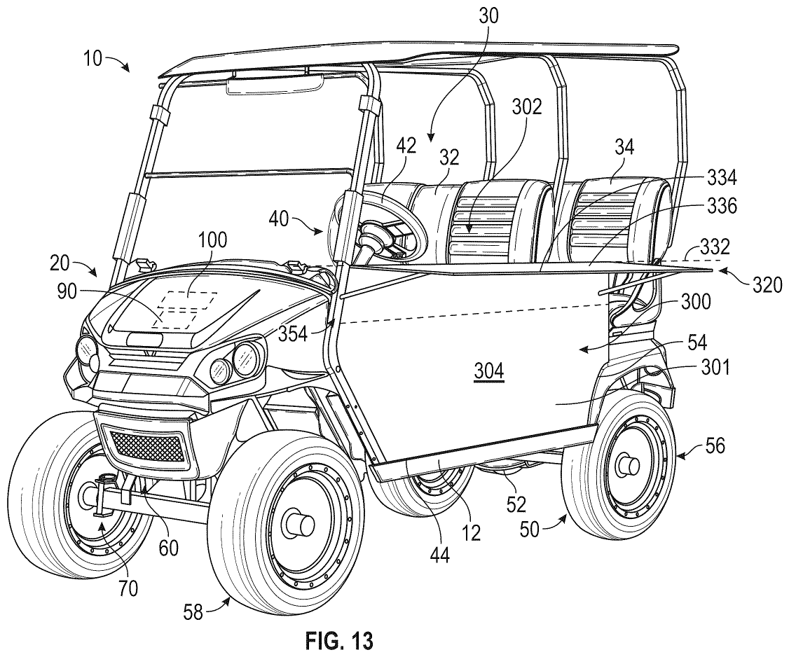

As shown in FIG. 13, in some embodiments, the door assembly 300 forms a table 334 in the second state and includes a plurality of supports, shown as supports 354. The door assembly 300 also defines at least a portion of the door 301. The supports 354 extend from the extension panel 336 to the main body 304 and are configured to provide support to the extension panel 336. The extension panel 336 pivots about the fourth pivot axis 332 on an external side of the main body 304 opposite the occupant seating area 30. In this embodiment, the vehicle 10 is used as a refreshment cart (e.g., a bar cart, a breakfast bar, etc.) configured to serve refreshments to users external to the vehicle 10. For example, a bartender may create drinks in the occupant seating area 30 and place the drinks on the extension panel 336 to serve users.

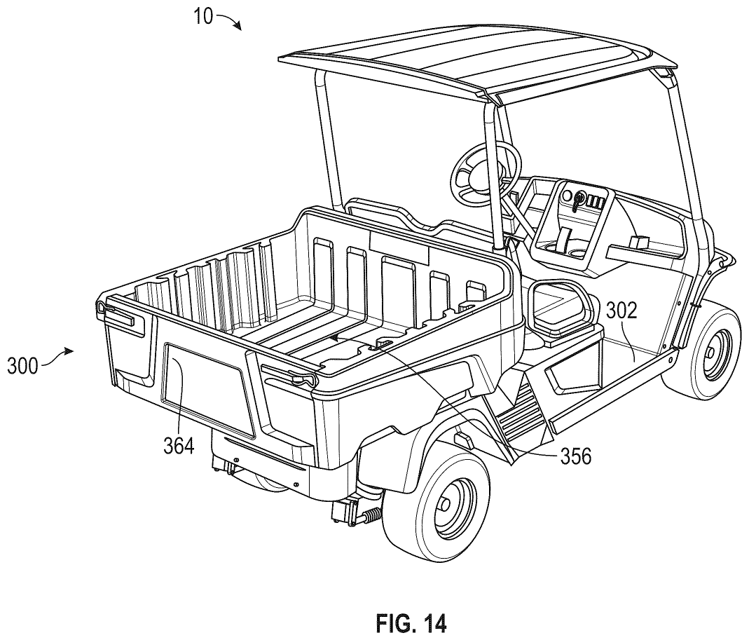

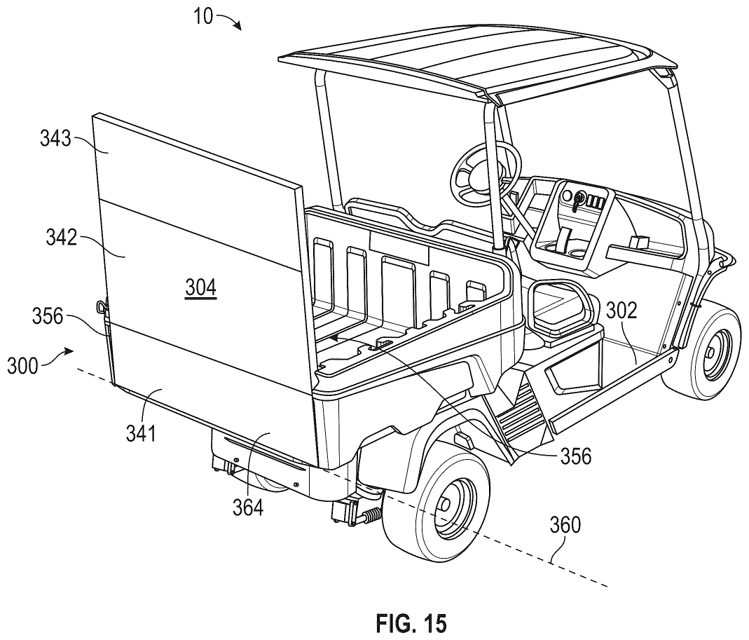

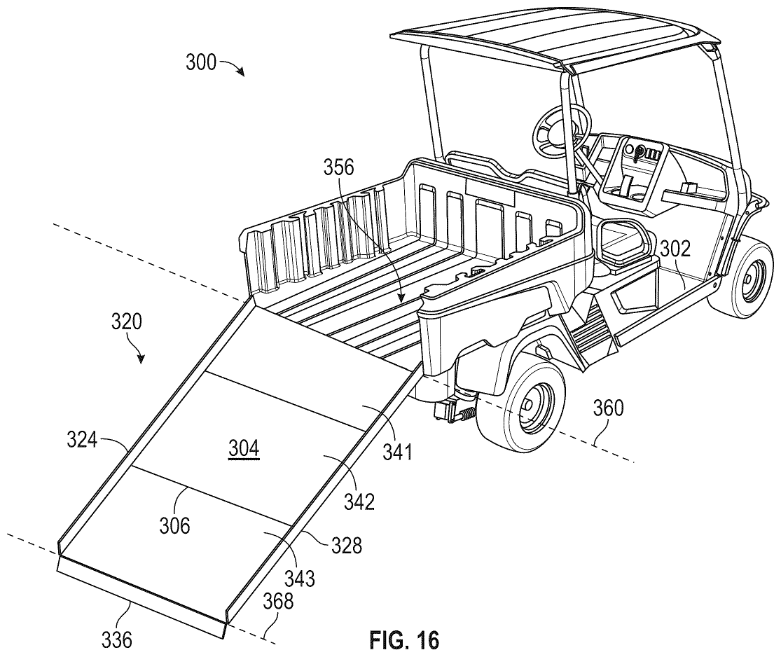

As shown in FIGS. 14-19, the vehicle 10 includes a bed, shown as cargo bed 356. The cargo bed 356 includes a door, shown as tailgate 364, and the door assembly 300 forms at least a portion of the tailgate 364 in the first state, according to an exemplary embodiment. In FIG. 14, the door assembly 300 defines the tailgate 364 in the first state and, in FIGS. 15 and 16, the door assembly 300 defines the ramp 306 in a second state, according to an exemplary embodiment. The door assembly 300 includes a fifth axis, shown as fifth pivot axis 360; and a sixth axis, shown as sixth pivot axis 368. The fifth pivot axis 360 extends along a bottom of the tailgate 364 (e.g., along an edge of the cargo bed 356). The sixth pivot axis 368 extends between the extension panel 336 and the main body 304. The sixth pivot axis 368 is substantially parallel and offset from the fifth pivot axis 360. As shown in FIG. 15, the main body 304 telescopes away from the cargo bed 356. As shown in FIG. 16, the main body 304 and pivots about the fifth pivot axis 360 towards the ground surface. The extension panel 336 then rotates about the sixth pivot axis 368 towards the ground to form the ramp 306. The ramp 306 is configured similar to the ramp 306 of FIGS. 5-7.

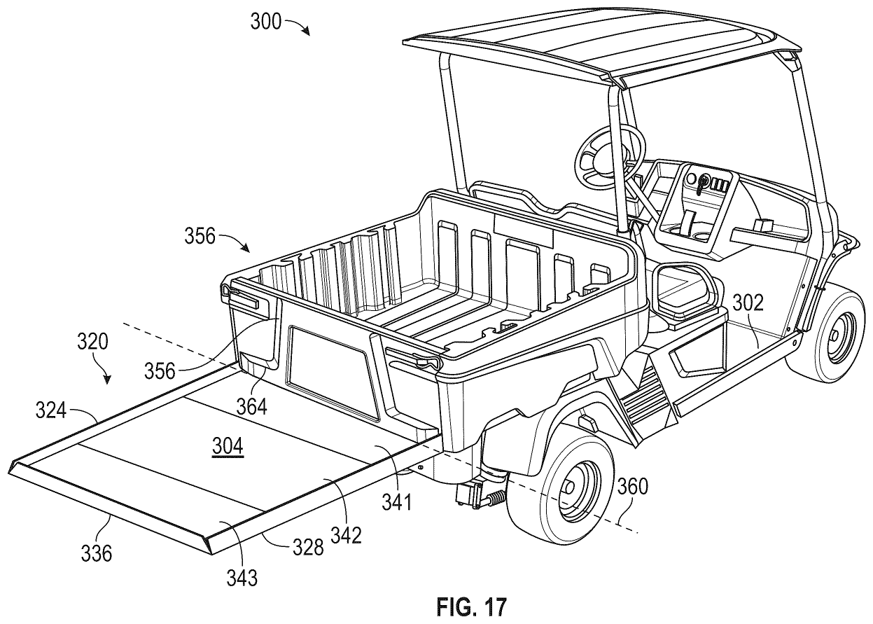

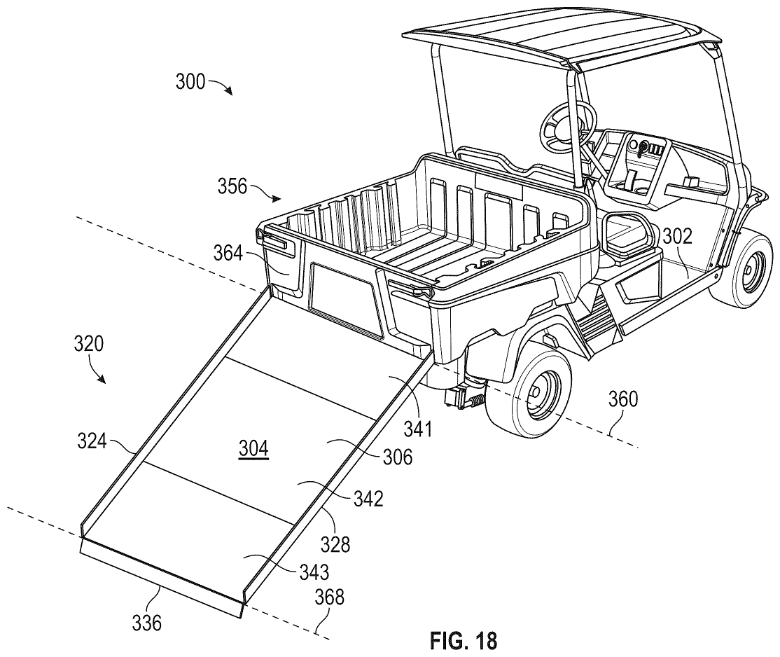

As shown in FIGS. 17 and 18, the door assembly 300 forms a portion of the tailgate 364 or is positioned beneath the tailgate 364 and the cargo bed 356 (e.g., in a recess or cavity) in the first state and forms the ramp 306 in the second state, according to an exemplary embodiment. As shown in FIG. 17, the door assembly 300 forms a bottom portion of the tailgate 364 in the first state. While transitioning from the first state to the second state, the main body 304 telescopes from a bottom of the tailgate 364 and is substantially parallel to the cargo bed 356. While transitioning from the first state to the second state, the main body 304 pivots about the fifth pivot axis 360 towards the ground. The extension panel 336 then pivots about the sixth pivot axis 368 to contact the ground surface, as shown in FIG. 18. The first rail 324 and the second rail 328 may also pivot as in FIGS. 5-7 to create a guard for cargo.

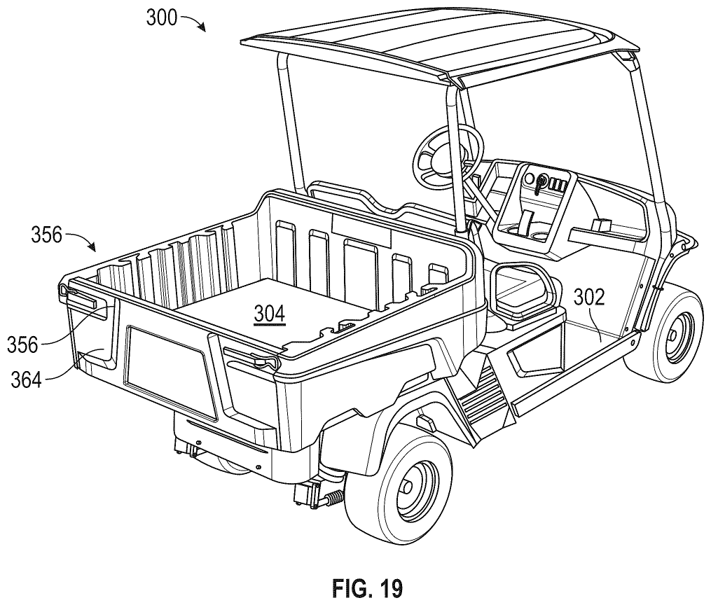

As shown in FIG. 19, the door assembly 300 is received within the cargo bed 356 in the first state, and couples to the cargo bed 356 in the second state to define the ramp 306. In some embodiments, the door assembly 300 forms a portion of the cargo bed 356 and a portion of the tailgate 364 in the first state. For example, the door assembly 300 forms a portion of the cargo bed 356, slides along the cargo bed 356, past the tailgate 364, and pivots towards the ground.

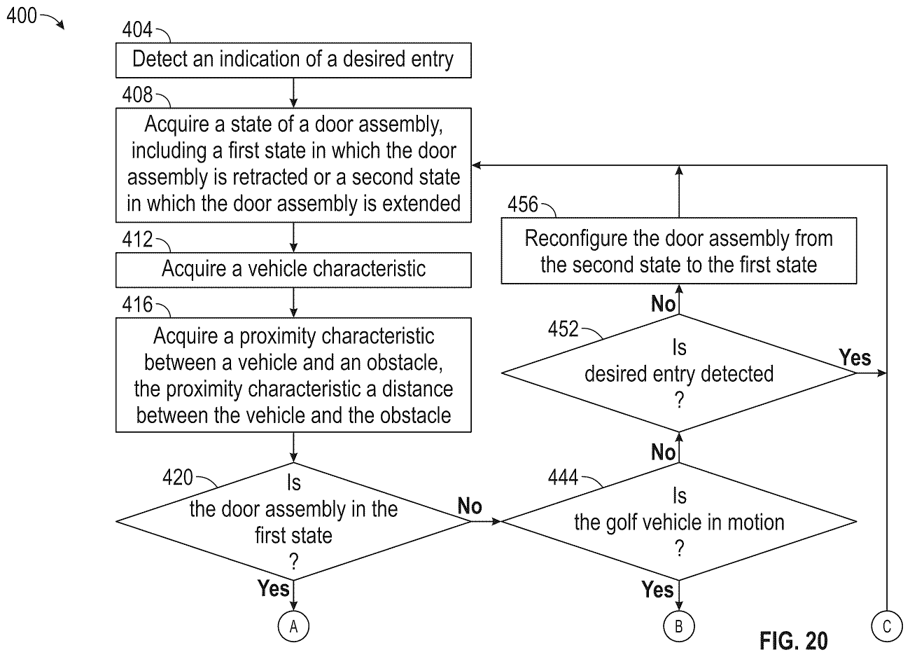

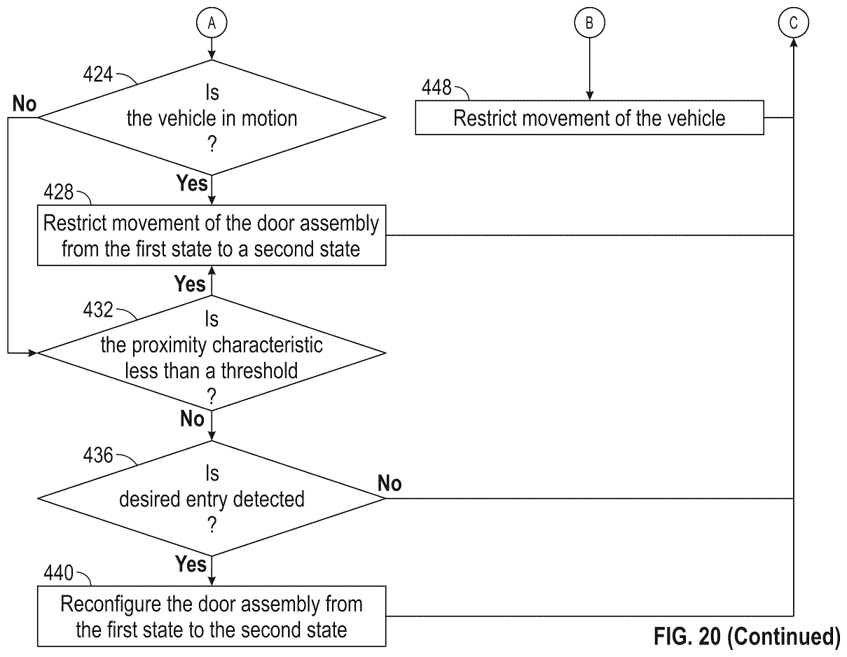

FIG. 20 shows a method 400 for reconfiguring the door assembly 300 between the first state and the second state. The method 400 may be performed by the site monitoring and control system 200, the vehicle control system 100, and/or the remote systems 240.

At step 404, at least one controller (e.g., the site monitoring and control system 200, the vehicle control system 100, the remote systems 240, etc.) is configured to detect an indication of a desired entry to the occupant seating area 30. In some embodiments, the indication of the desired entry is acquired from the sensors 90 determining motion outside of the vehicle 10. For example, the sensors 90 may include a motion sensor configured to detect a visual cue, such as a motion of a hand wave from a user. In some embodiments, the indication of the desired entry is acquired from the sensors 90 determining an auditory cue. For example, the sensors 90 may include a sound sensor (e.g., a microphone) configured to detect an auditory cue, such as a hand clap or a pattern of hand claps. In some embodiments, the indication of the desired entry is acquired from the sensors 90 determining a tactile (e.g., touch, etc.) cue. For example, the sensors 90 may include a pressure sensor configured to detect pressure along a portion of the door assembly 300. In some embodiments, the indication of the desired entry is acquired from the user device 232 (e.g., key fob, smartphone, etc.). For example, a user may interact with the user device 232 to request entry to the vehicle 10.

At step 408, the controller is configured to acquire a state of the door assembly 300. The state includes a first state in which the door assembly 300 is retracted and a second state in which the door assembly 300 is extended. In the first state, the door assembly 300 defines at least a portion of a door 301. In the second state, the door assembly 300 defines at least one of a ramp 306, a table 334, or a bed 335.

At step 412, the controller is configured to acquire a vehicle characteristic. The vehicle characteristic includes an indication that the vehicle 10 is in motion. The vehicle characteristic may be acquired from the sensor 90 or GPS data acquired by a GPS device (e.g., a user sensor 220, a vehicle GPS of the vehicle 10, etc.). The vehicle characteristic may include at least one of a speed of the vehicle 10, an acceleration of the vehicle 10, a speed of the tractive assemblies 56, 58, a speed of the prime mover 52 (e.g., the motor 53), an acceleration of the prime mover 52, an acceleration of the tractive assemblies 56, 58, a torque of the prime mover 52, and/or a current draw of the prime mover 52.

At step 416, the controller is configured to acquire a proximity characteristic between the vehicle 10 and an obstacle (e.g., hazard, water, woods, person, etc.). The proximity characteristic is a distance between the vehicle 10 and the obstacle. The proximity characteristic is determined from input from the sensors 90. For example, the sensors 90 may include (1) an image recognition sensor that records an image and identifies and classifies an object in the image and (2) a Light Detection and Ranging sensor (LiDAR) that determines a distance between the vehicle 10 and the object. The obstacles may impede the ability of the door assembly 300 to reconfigure from the first state to the second state. For example, when the door assembly 300 and/or the second door assembly 352 reconfigures from the first state to the second state to form a ramp 306, the ramp 306 may impact the obstacle, damaging the ramp 306 and the object and/or preventing a user from accessing the ramp 306. In some embodiments, the proximity characteristic also indicates the direction of the obstacle (e.g., the proximity characteristic is a vector quantity, etc.).

At step 420, the controller is configured to determine if the door assembly 300 is in the first state. If the controller determines the door assembly 300 is in the first state where the door assembly 300 defines at least a portion of a door 301, the controller is configured to proceed to step 424. At step 424, the controller is configured to determine if the vehicle 10 is in motion. The controller determines if the vehicle 10 is in motion in accordance with the vehicle characteristic acquired in step 412. For example, if the vehicle characteristic indicates that the vehicle is undergoing acceleration or deceleration the controller determines the vehicle 10 is in motion. If the controller determines the vehicle 10 is in motion, the controller is configured to proceed to step 428.

At step 428, the controller is configured to restrict movement of the door assembly 300 from the first state to the second state. Restricting movement of the door assembly 300 from the first state to the second state may prohibit damage to the door assembly 300 and the surroundings of the vehicle 10. For example, extending the door assembly 300 to define a ramp 306 while the vehicle 10 is in motion may lead to the door assembly 300 dragging and bouncing on turf, damaging the ramp 306 and the turf. In another example, extending the door assembly 300 to define a table 334 or a bed 335 while the vehicle 10 is in motion may lead to the door assembly 300 damaging cargo within the occupant seating area 30. The controller is then configured to proceed to step 408 and acquire the state of the door assembly 300.

If the controller determines at step 424 that the vehicle 10 is not in motion, the controller is configured to proceed to step 432. At step 432, the controller is configured to determine if the proximity characteristic is less than a threshold. The threshold is a minimum allowable distance between the obstacle and the vehicle 10 or the door assembly 300. In some embodiments, there are multiple thresholds for each obstacle type. For example, if at step 416 the controller determines there is a human a first distance from the door assembly 300 and a puddle a second distance from the door assembly 300, the controller may compare the first distance to a first threshold and the second distance to a second threshold different than the first threshold. In some embodiments, there are multiple thresholds for each orientation of the obstacles with respect to the door assembly 300. For example, if at step 416 the controller determines that there is a first obstacle 45 degrees with respect to the front of the vehicle 10 and a second obstacle at 90 degrees clockwise with respect to the front of the vehicle 10, the controller may compare the orientation of the first obstacle to a first threshold and the orientation of the second obstacle to a second threshold, the first threshold greater than the second threshold. If the controller determines the proximity characteristic is less than the threshold, the controller is configured to proceed to step 428, to restrict movement of the door assembly 300 from the first state to the second state.

If the controller determines the proximity characteristic is not less than the threshold, the controller is configured to proceed to step 436. At step 436, the controller is configured to determine if desired entry is detected, as detected in step 404. If the controller determines desired entry, the controller is configured to proceed to step 440. At step 440, the controller is configured to reconfigure the door assembly 300 from the first state to the second state. Reconfiguring the door assembly 300 from the first state to the second state includes rotating the door assembly 300 about a pivot point, extending a portion of the door assembly 300, and/or moving a portion of the door assembly 300 to reconfigure the door assembly 300 to be at least one of a ramp 306, a table 334, or a bed 335. For example, when the second state is the ramp 306, the main body 304 is configured to rotate about the first pivot axis 316 towards the ground surface, the first rail 324 is configured to rotate about the second pivot axis 318 away from the ground surface, the second rail 328 is configured to rotate about the third pivot axis 319 away from the ground surface, and the extension panel 336 is configured to rotate about the fourth pivot axis 332 towards the ground surface to contact the ground surface. The controller is then configured to proceed to step 408. If the controller determines at step 436 that detected entry is not detected, the controller is configured to proceed to step 408.

At step 420, if the controller determines the door assembly 300 is not in the first state, the controller is configured to proceed to step 444. At step 444, the controller is configured to determine if the vehicle 10 is in motion. The controller determines if the vehicle 10 is in motion in accordance with the vehicle characteristic acquired in step 412. If the controller determines the vehicle 10 is in motion, the controller is configured to proceed to step 448. At step 448 the controller is configured to restrict movement of the vehicle 10. Restricting movement of the vehicle 10 when not in the first state may be used when the second state is a ramp 306 (e.g., to prevent the ramp 306 from damaging the surroundings or being damaged by the surroundings while the vehicle 10 is in motion, etc.). In some embodiments, step 448 is omitted. For example, when the second state is a table 334 the controller may enable the vehicle 10 to move. The controller then proceeds to step 404.

If the controller determines at step 444 the vehicle 10 is not in motion, the controller is configured to proceed to step 452. At step 452, the controller is configured to determine if desired entry is detected. If the controller determines desired entry is detected, as detected in step 404, the controller is configured to proceed to step 408. For example, if the second state is the ramp 306 and the desired entry is detected, the door assembly 300 is not reconfigured to the first state, because the ramp 306 is used for entry. In some embodiments, such as when the second state is a table 334 or a bed 335, step 452 is omitted. If the controller determines desired entry is not detected, the controller is configured to proceed to step 456. At step 456, the controller is configured to reconfigure the door assembly 300 from the second state to the first state. In some embodiments, such as when the second state is a table 334 or a bed 335, step 452 is omitted.

The method 400 may also be repeated or executed in tandem with the second door assembly 352 instead of or in addition to the door assembly 300. During step 408, the controller acquires a state of the second door assembly 352 instead of or in addition to the door assembly 300. The states include a third state where the second door assembly 352 is retracted and a fourth state in which the second door assembly 352 is extended. In the third state, the second door assembly 352 defines at least a portion of a second door 301 for the occupant seating area 30, and in the fourth state, the second door assembly 352 defines at least one of a ramp 306, a table 334, or a bed 335. The fourth state is different than the second state. For example, the second state may define a ramp 306 and the fourth state may define a table 334.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent, or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A recreational vehicle comprising:
a chassis;
a body coupled to the chassis, the body defining an occupant area; and
a door assembly reconfigurable between (i) a first state in which the door assembly defines at least a portion of a door for the occupant area and (ii) a second state in which the door assembly defines at least one of a ramp, a table, or a bed.

2. The recreational vehicle of claim 1, further comprising:
a sensor configured to facilitate detecting a vehicle characteristic; and
a control system configured to:
acquire a state of the door assembly;
acquire the vehicle characteristic from the sensor;
restrict movement of the door assembly from the first state to the second state in response to determining that the recreational vehicle is in motion based on the vehicle characteristic; and
restrict movement of the recreational vehicle when the control system determines the door assembly is in the second state.

3. The recreational vehicle of claim 1, wherein the recreational vehicle is a golf vehicle, a personal transport vehicle, a low speed vehicle, a utility task vehicle, or a light utility vehicle.

4. The recreational vehicle of claim 1, further comprising:
a sensor; and
a control system configured to:
acquire a proximity characteristic from the sensor, wherein the proximity characteristic includes a distance between the recreational vehicle and an obstacle; and
restrict movement of the door assembly from the first state to the second state when the distance is less than a threshold.

5. The recreational vehicle of claim 1, wherein the door assembly is extended or retracted between the first state and the second state by at least one of a motor, an electric actuator, a pneumatic actuator, or a spring.

6. The recreational vehicle of claim 1, wherein, in the second state the door assembly, defines the ramp, and wherein the door assembly includes:
a main body pivotably coupled to a lateral edge of the chassis; and
at least one of:
one or more rails extending along edges of the main body; and
an extension portion extending along a free end of the main body, the extension portion configured to contact a ground surface when the door assembly is in the second state.

7. The recreational vehicle of claim 6, wherein:
the door assembly includes the one or more rails and the extension portion;
the main body is pivotable relative to the lateral edge of the chassis about a first pivot axis;
the one or more rails include:
a first rail pivotable relative to the main body about a second pivot axis; and
a second rail pivotable relative to the main body about a third pivot axis; and
the extension portion is pivotable relative to the main body about a fourth pivot axis.

8. The recreational vehicle of claim 1, further comprising a control system configured to:
acquire a state of the door assembly;
acquire an indication of a desired entry to the occupant area; and
reconfigure the door assembly from the first state to the second state when the door assembly is in the first state and in response to the indication;
wherein, in the second state the door assembly defines the ramp.

9. The recreational vehicle of claim 8, wherein reconfiguring the door assembly from the first state to the second state includes rotating the door assembly about a pivot point.

10. The recreational vehicle of claim 1, wherein the door assembly is a first door assembly and the door is a first door, further comprising a second door assembly reconfigurable between (i) a third state in which the second door assembly defines at least a portion of a second door for the occupant area and (ii) a fourth state in which the door assembly defines at least one of the ramp, the table, or the bed, and wherein the second state and the fourth state are different.

11. The recreational vehicle of claim 1, wherein the door assembly is reconfigurable between the first state, the second state, and a third state, wherein the second state defines at least one of the table or the bed, and wherein the third state defines the ramp.

12. The recreational vehicle of claim 1, wherein the door assembly includes:
a main body pivotably coupled the chassis, the main body providing the door; and
an extension portion pivotably coupled to the main body;
wherein, in the second state, the extension portion extends substantially perpendicular from the main body to define the table or the bed.

13. The recreational vehicle of claim 12, wherein:
the door assembly includes one or more legs;
in the first state, the one or more legs are coupled to the main body; and
in the second state, the one or more legs are coupled to the extension portion.

14. The recreational vehicle of claim 13, wherein the extension portion include a plurality of telescoping portions that telescope to define the table or the bed.

15. The recreational vehicle of claim 12, wherein the door assembly includes one or more legs pivotably coupled to the extension portion.

16. The recreational vehicle of claim 12, wherein the door is a first door extending along a first side of the occupant area, further comprising a second door extending along a second side of the occupant area opposite the first side, and wherein the extension portion telescopes from the main body to the second door, a free end of the extension portion supported by the second door.

17. The recreational vehicle of claim 1, wherein the door assembly includes:
a main body pivotably coupled the chassis, the main body providing the door; and
a tabletop;
wherein, in the first state, the tabletop is stowed and, in the second state, the tabletop extends laterally outward from the main body.

18. The recreational vehicle of claim 1, further comprising a cargo bed including a tailgate, wherein the tailgate is reconfigurable into the ramp for the cargo bed.

19. A recreational vehicle comprising:
a chassis;
a body coupled to the chassis, the body defining an occupant area;
one or more sensors;
a door assembly reconfigurable between (i) a first state in which the door assembly defines at least a portion of a door for the occupant area and (ii) a second state in which the door assembly defines at least one of a ramp, a table, or a bed; and
a control system configured to:
acquire a state of the door assembly;
acquire a vehicle characteristic from the one or more sensors;
acquire a proximity characteristic from the one or more sensors, wherein the proximity characteristic includes a distance between the recreational vehicle and an obstacle;
restrict movement of the door assembly from the first state to the second state in response to determining that the recreational vehicle is in motion based on the vehicle characteristic;
restrict movement of the recreational vehicle when the door assembly is in the second state; and
restrict movement of the door assembly from the first state to the second state when the distance is less than a threshold.

20. A recreational vehicle comprising:
a chassis;
a body coupled to the chassis, the body defining an occupant area; and
a door assembly including:
a main body; and
an extension panel pivotably coupled to the main body,
wherein the door assembly is reconfigurable between (i) a first state in which the main body provides at least a portion of a door for the occupant area, (ii) a second state in which the main body and the extension panel provides a ramp, and (iii) a third state in which the extension panel provides a tabletop.
